(19) United States
(12) Patent Application Publication
(10) Pub. No.: US 2017/0199951 A1
(43) Pub. Date: Jul. 13, 2017

(54) SYSTEM AND METHOD OF PREDICTING FUTURE OCCURRENCE OF ONE OR MORE HISTORICAL EVENTS

(71) Applicant: Wipro Limited, Bangalore, IN (US)

(72) Inventors: Balakrishnan RAJARAMAN, Kolkata (IN); Sreeja HARINARAYANAN, Udumalpet (IN)

(73) Assignee: Wipro Limited

(21) Appl. No.: 15/052,929

(22) Filed: Feb. 25, 2016

(30) Foreign Application Priority Data
Jan. 13, 2016 (IN) 201641001264

(51) Int. Cl. G06F 17/50

(52) U.S. Cl. CPC G06F 17/5009

(57) ABSTRACT

A disaster management system and method for predicting future occurrence of one or more historical events, the system comprising: a memory; a processor coupled to the memory storing processor executable instructions which when executed by the processor causes the processor to perform operation comprising: identifying a unique parameter based on historical data associated with the one or more historical events; creating an event object based on the unique parameter; determining one or more deviations of the event object from the one or more historical events; and predicting future occurrence of the one or more historical events based on the one or more deviations.

### PRIORITY CLAIM

This U.S. patent application claims priority under 35 U.S.C. §119 to: India Application No. 201641001264, filed Jan. 13, 2016. The aforementioned applications are incorporated herein by reference in their entirety.

### TECHNICAL FIELD

This disclosure relates generally to disaster management, and more particularly to system and method of predicting future occurrence of one or more historical events.

### BACKGROUND

Accidents or disasters may have a huge impact to the infrastructure set up as well as to human life. While natural disasters may not stopped but the damages can be controlled to a large extent. On the other hand manmade disasters may be stopped or controlled. Manmade disasters may be caused due to a malfunction in a mechanical or electrical device. Damages caused by these disasters may be controlled to a large extent if the malfunction in the mechanical or electrical device is avoided.

### SUMMARY

A method for predicting future occurrence of one or more historical events, the method comprising: identifying, by a disaster management system, a unique parameter based on historical data associated with the one or more historical events; creating, by the disaster management system, an event object based on the unique parameter; determining, by the disaster management system, one or more deviations of the event object from the one or more historical events; and predicting, by the disaster management system, future occurrence of the one or more historical events based on the one or more deviations.

A disaster management system to predict future occurrence of one or more historical events comprising: a memory; a processor coupled to the memory storing processor executable instructions which when executed by the processor causes the processor to perform operation comprising: identifying a unique parameter based on historical data associated with the one or more historical events; creating an event object based on the unique parameter; determining one or more deviations of the event object from the one or more historical events; and predicting future occurrence of the one or more historical events based on the one or more deviations.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary diagram for an environment with a disaster management system.

FIG. 2 illustrates the memory of the disaster management system which may include data transformation unit, unique parameter identifier, event object creator, rules creator, deviations analyzer and prediction unit.

FIG. 3 illustrates an exemplary flow diagram of a method for predicting future occurrence of one or more historical events.

FIG. 4 illustrates an exemplary embodiment wherein the disaster management system may be applied to a pipeline system in an oil refinery.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

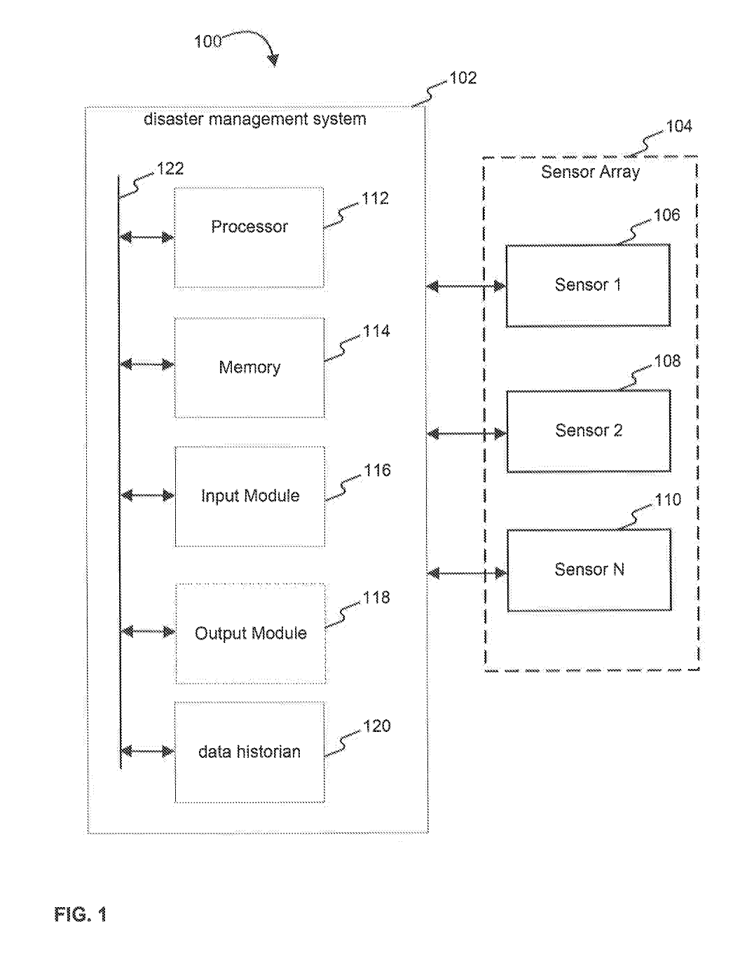

FIG. 1 illustrates an exemplary diagram for an environment 100 with a disaster management system 102. The exemplary environment 100 may include the disaster management system 102, a sensor array 104. The disaster management system 102 may further include a processor 110, a memory 112, an input module 114, an output module 116, and a data historian 118. While not shown, the exemplary environment 100 may include additional components, such as database which are well known to those of ordinary skill in the art and thus will not be described here. The sensor array 104 may include one or more sensors connected to a mechanical or electrical system to capture one or more sets of parameters associated with a mechanical or electrical system, environmental conditions surrounding the mechanical or electrical system.

The disaster management system 102 may predict future occurrence of one or more historical events and is described with examples herein, although the disaster management system 102 may perform other type of functions also. The disaster management system 102 may include a processor 112, a memory 114, an input module 116, an output module 118, and a data historian 120 which may be coupled together by bus 122, although the disaster management system 102 may comprise other types and numbers of element in other configurations.

Processor 112 may execute one or more computer-executable instructions stored in the memory 114 for the methods illustrated and described with reference to the examples herein, although the processor(s) can execute other types and numbers of instructions and perform other types and numbers of operations. The processor(s) 112 may comprise one or more central processing units (“CPUs”) or general purpose processors with one or more processing cores, such as AMD® processor(s), although other types of processor(s) could be used (e.g., Intel®).

The memory 114 may comprise one or more tangible storage media, such as RAM, ROM, flash memory, CD-ROM, floppy disk, hard disk drive(s), solid state memory, DVD, or other memory storage types or devices, including combinations thereof, which are known to those of ordinary skill in the art. The memory 114 may store one or more non-transitory computer-readable instructions of this technology as illustrated and described with reference to the examples herein that may be executed by the one or more processor(s) 112.

The input module 116 may receive one or more sensor data from the sensor array 104.

The output module 118 may link the production surveillance device 102 with peripheral devices to execute preventive measures, monitoring mechanism and alert mechanism.

The data historian 120 may be a real-time data-delivery mechanism, performing mathematical operations that aggregate and transform acquired data. The data historian 120 may be used to record trends and historical information about industrial processes for future reference. The data historian 120 may capture plant management information about production status, performance monitoring, quality assurance, tracking and genealogy, and product delivery with enhanced data capture, data compression, and data presentation capabilities. The one or more sensor data captured may be relayed into the data historian where the one or more sensor data can be stored.

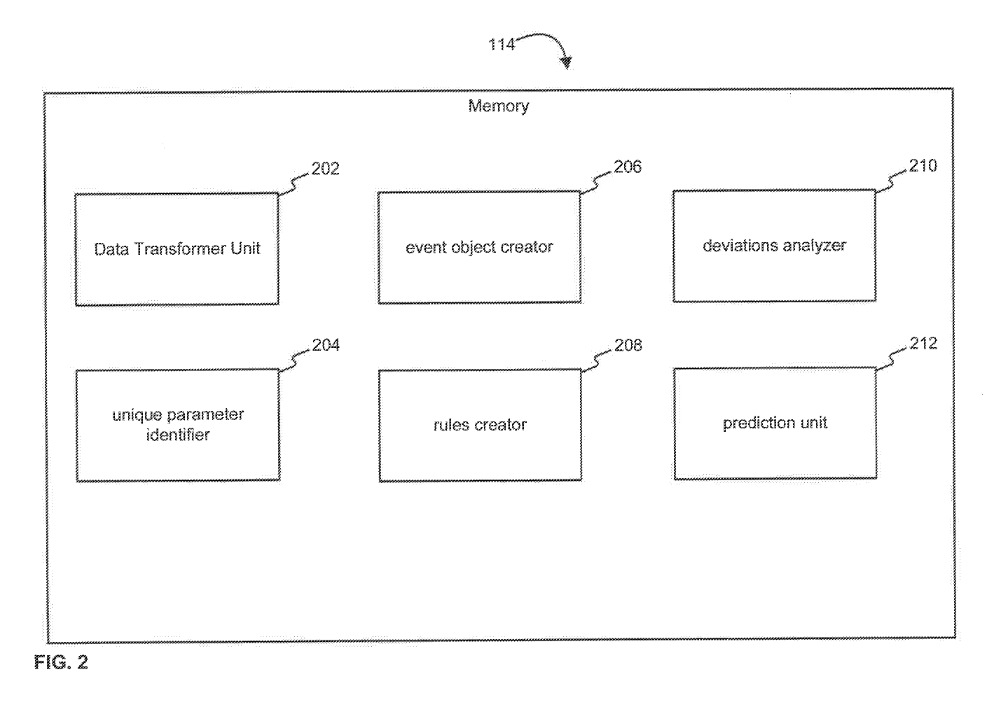

FIG. 2 illustrates the memory 114 which may include data transformation unit 202, unique parameter identifier 204, event object creator 206, rules creator 208, deviations analyzer 210 and prediction unit 212. The data transformation unit 202 may convert historical data into a desire format such as JMS messages. The historical data associated with the one or more historical events may have been collected through one or more sensors. The historical data may have been stored in a data historian 120. After the data is transformed, the unique parameter identifier 204 may identify a unique parameter based on historical data associated with the one or more historical events. Identifying the unique parameter by unique parameter identifier 204 may comprise identifying one or more sets of parameters based on the historical data associated with the one or more historical events; extracting relationship between the one or more sets of parameters; and identifying a unique parameter among the one or more sets of parameter based on the relationship. The one or more sets of parameters may be functional properties associated with a mechanical or electrical system, environmental conditions surrounding the mechanical or electrical system. For example, in a pipeline system, pipe pressure, pipe erosion, pipe length may be the functional properties associated with the pipeline system. Environment condition surrounding the pipeline system may be temperature change, exposure to moisture, corrosive elements. The one or more sets of parameter may be correlated by the unique parameter identifier 204 to extract relationship between each of the one or more sets of parameters. The correlation may disclose interdependence of each of the one or more sets of parameters on other one or more sets of parameters. The interdependence of each of the one or more sets of parameters on other one or more sets of parameters may lead to extracting relationship between each of the one or more sets of parameters. The unique parameter may be identified among the one or more sets of parameter based on the relationship extracted between each of the one or more sets of parameters. The unique parameter may be the parameter among the one or more sets parameter which directly affects between each of the one or more sets of parameters. Any change in the unique parameter may lead to a change in the relationship between each of the one or more sets of parameters.

After identification of the unique parameter, event creator 206 may create an event object based on the identified unique parameter. The event object creator 206 may mark any change in the one or more sets of parameters as an event. The event object creator 206 may mark one or more changes in the one or more sets of parameters as one or more events while keeping the unique parameter as a baseline. The event object creator 206 may create a pattern of the one or more events leading to the one or more historical events based on the unique parameter. The unique parameter may be a baseline parameter or a default parameter, around which the event object may create the pattern of the one or more events. The event object may be a model of the pattern pertaining to the one or more events leading to the one or more historical events based on the unique parameter. After the pattern of one or more events is created, one or more logical rules may be formed based on the pattern of one or more events leading to the one or more historical events by rules creator 208. The one or more logical rules may be logical steps to execute preventive measures, a monitoring mechanism and an alert mechanism.

After the event object is created, deviations analyzer 210 may determine one or more deviations of the event object from the historical events. The determining of the one or more deviations by deviations analyzer 210 may comprise monitoring the event object based on real time data; comparing the monitored event object to the one or more historical event; and determining the one or more deviations of the event object based on the comparison. After the event object creator 206 creates the model of the pattern pertaining to the one or more events, the event object may be monitored based on real time data received from the one or more sensors in sensor array 104. During the monitoring process the event object may be compared to the one or more historical events. The pattern of one or more events created by the event object may be compared to the real time data 'received from the one or more sensors. One or more deviations may be determined based on the comparison. One or more deviations may be any change in the model of the pattern pertaining to the one or more events, when compared with the real time data for each of the one or more sets of parameters.

Deviation=(Real time Value−Historical Value) for each set of parameter

After the one or more deviations are determined, the prediction unit 212 may predict future occurrence of the one or more historical events may be predicted based on the one or more deviations. The one or more deviations may help in determining a criticality factor (CF) associated with each of the one or more events by the prediction unit 212. The criticality factor (CF) may be a comparison of the one or more deviations with a pre-defined threshold.

Criticality factor=((Real time Value−Historical Value)/Threshold Value)*number of parameters affected.

The future occurrence of the one or more historical events may be predicted based on the criticality factor of each of the one or more events. Each event of the one or more events with the criticality factor above a pre-defined criticality threshold may lead to the one or more historical events. Once the criticality factor each of the one or more events is determined, the one or more logical rule may be triggered based on the one or more deviations to generate alert mechanism or preventive measures.

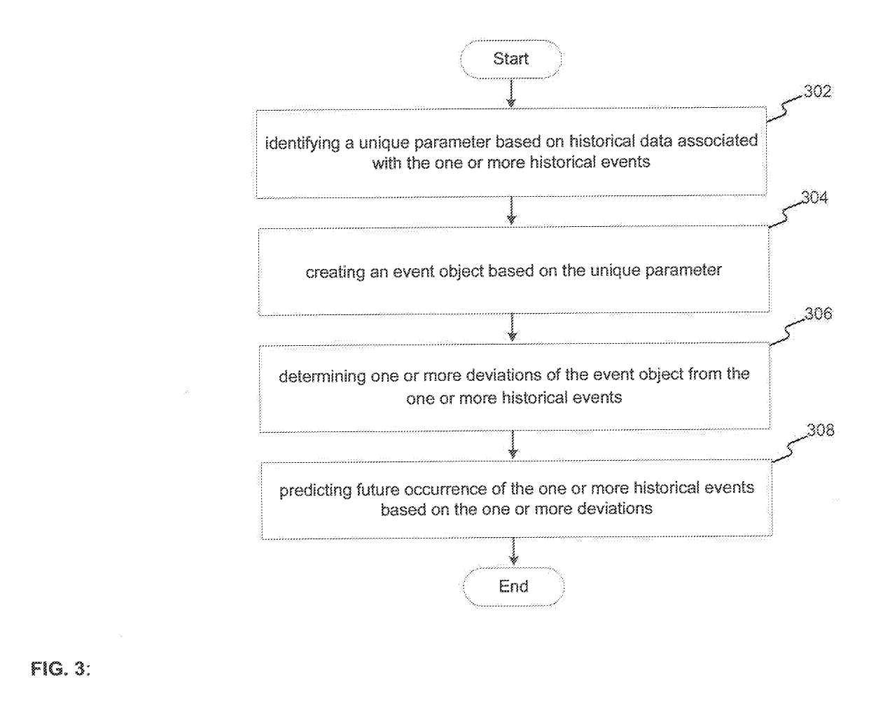

FIG. 3 illustrates an exemplary flow diagram of a method for predicting future occurrence of one or more historical events. The method may involve identifying, a unique parameter based on historical data associated with the one or more historical events by the disaster management system 102 at step 302. The historical data associated with the one or more historical events may have been collected through one or more sensors. The historical data may have been stored in a data historian 120. The historical data stored may be converted into a desired format such as JMS messages by data transformation unit 202. Identifying the unique parameter by unique parameter identifier 204 may comprise identifying one or more sets of parameters based on the historical data associated with the one or more historical events; extracting relationship between the one or more sets of parameters; and identifying a unique parameter among the one or more sets of parameter based on the relationship. The one or more sets of parameters may be functional properties associated with a mechanical or electrical system, environmental conditions surrounding the mechanical or electrical system. For example, in a pipeline system, pipe pressure, pipe erosion, pipe length may be the functional properties associated with the pipeline system. Environment condition surrounding the pipeline system may be temperature change, exposure to moisture, corrosive elements. The one or more sets of parameter may be correlated by the unique parameter identifier 204 to extract relationship between each of the one or more sets of parameters. The correlation may disclose interdependence of each of the one or more sets of parameters on other one or more sets of parameters. The interdependence of each of the one or more sets of parameters on other one or more sets of parameters may lead to extracting relationship between each of the one or more sets of parameters. The unique parameter may be identified among the one or more sets of parameter based on the relationship extracted between each of the one or more sets of parameters. The unique parameter may be the parameter among the one or more sets parameter which directly affects between each of the one or more sets of parameters. Any change in the unique parameter may lead to a change in the relationship between each of the one or more sets of parameters.

After identifying the unique parameter, an event object based may be created based on the identified unique parameter by the disaster management system 102 at step 304. The event object may be created by event object creator 206. The event object creator 206 may mark any change in the one or more sets of parameters as an event. The event object creator 206 may mark one or more changes in the one or more sets of parameters as one or more events while keeping the unique parameter as a baseline. The event object creator 206 may create a pattern of the one or more events leading to the one or more historical events based on the unique parameter. The unique parameter may be a baseline parameter or a default parameter, around which the event object may create the pattern of the one or more events. The event object may be a model of the pattern pertaining to the one or more events leading to the one or more historical events based on the unique parameter. After the pattern of one or more events is created, one or more logical rules may also be formed based on the pattern of one or more events leading to the one or more historical events by rules creator 208. The one or more logical rules may be logical steps to execute preventive measures, monitoring mechanism and alert mechanism.

After the event object is created, one or more deviations may be determined of the event object from the historical events, by the disaster management system 102 at step 306. The determining of the one or more deviations by deviations analyzer 210 may comprise monitoring the event object based on real time data; comparing the monitored event object to the one or more historical event; and determining the one or more deviations of the event object based on the comparison. After the event object creator 206 creates the model of the pattern pertaining to the one or more events, the event object may be monitored based on real time data received from the one or more sensors in sensor array 104. During the monitoring process the event object may be compared to the one or more historical events. The pattern of one or more events created by the event object may be compared to the real time data 'received from the one or more sensors. One or more deviations may be determined based on the comparison. One or more deviations may be any change in the model of the pattern pertaining to the one or more events, when compared with the real time data for each of the one or more sets of parameters.

Deviation=(Real time Value−Historical Value) for each set of parameter

After determining the one or more deviations, future occurrence of the one or more historical events may be predicted based on the one or more deviations by the disaster management system 102 at step 308. The one or more deviations may help in determining a criticality factor (CF) associated with each of the one or more events by the prediction unit 212. The criticality factor (CF) may be a comparison of the one or more deviations with a pre-defined threshold.

Criticality factor=((Real time Value−Historical Value)/Threshold Value)*number of parameters affected.

The future occurrence of the one or more historical events may be predicted based on the criticality factor of each of the one or more events. Each event of the one or more events with the criticality factor above a pre-defined criticality threshold may lead to the one or more historical events. Once the criticality factor each of the one or more events is determined, the one or more logical rule may be triggered based on the one or more deviations to generate alert mechanism or preventive measures.

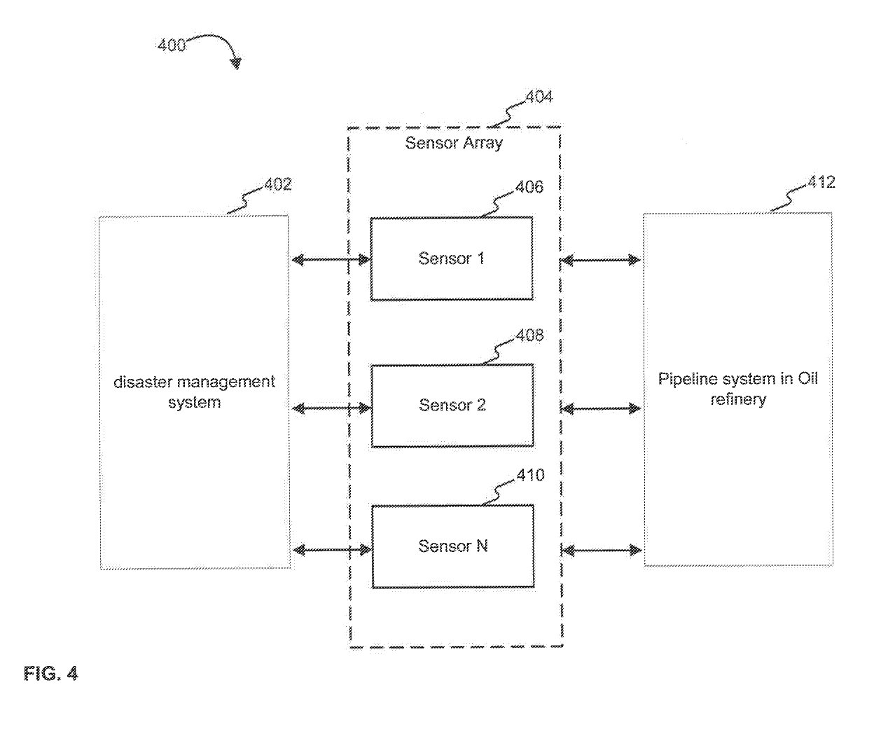

FIG. 4 illustrates an exemplary embodiment 400 wherein the disaster management system 402 may be applied to a pipeline system in an oil refinery 412 wherein pipeline leakage or pipeline explosion may be the one or more historical events. Historical data associated with the pipeline leakage or explosion by be detected by the sensor array 404. The historical data associated with the pipeline leakage or explosion may be stored in the data historian 120. The historical data may be converted into JMS format. The historical data may be sent to unique parameter identifier 204 using JMS queues by the data transformation unit 202. The one or more sets of parameters for the pipeline system may be pipe pressure, pipe erosion, pipe length, source pressure. The unique parameter may be identified as pipeline number of each pipe by unique parameter identifier 204. A model of pattern of one or more events may be created using the historical data based on the unique parameter by event object creator 206. The model of the pattern may be an event object. Once the event object is created, one or more logical rules are also formulated by the rules creator 208. For example Rule 1 may be fetching historical data about the pipeline from the memory using the pipeline number (unique identifier) which was used for creating the event object. Rule 2 may be comparison of real time data associated with oil source pressure and historical data associated with oil source pressure. If the deviation is high or negative, then the criticality factor is also high. Rule 3 may trigger comparison of erosion of the pipeline. If the deviation is high or negative, then the criticality factor is also high. Rule 4 may predict the chance of leakage or explosion to be very high. Rule 5 may be to reduce the source pressure and issuing a general alert in the oil refinery. All the logical rules may be triggered based on the event object created by the pattern of one or more events leading to the pipeline leakage or explosion.

### Computer System

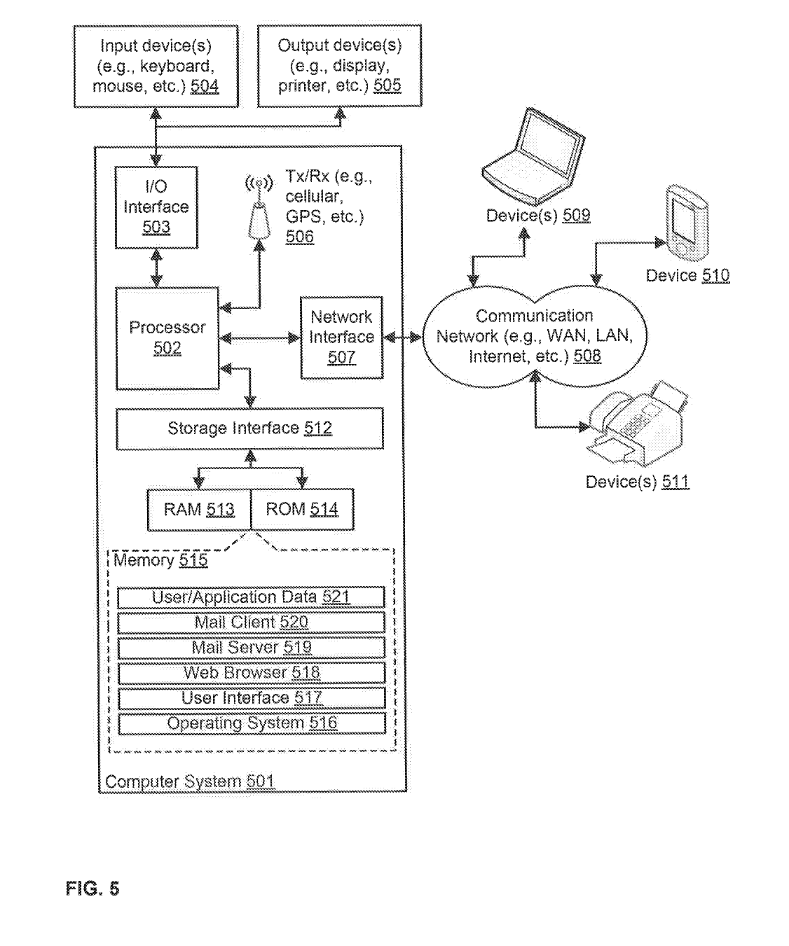

FIG. 5 is a block diagram of an exemplary computer system for implementing embodiments consistent with the present disclosure. Variations of computer system 501 may be used for implementing disaster management system. Computer system 501 may comprise a central processing unit (“CPU” or “processor”) 502. Processor 502 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11ab/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 510, 511, and 512. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. (e.g., list here) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

The specification has described system and method of predicting future occurrence of one or more historical events. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for predicting future occurrence of one or more historical events, the method comprising:
identifying, by a disaster management system, a unique parameter based on historical data associated with the one or more historical events;
creating, by the disaster management system, an event object based on the unique parameter;
determining, by the disaster management system, one or more deviations of the event object from the one or more historical events; and
predicting, by the disaster management system, future occurrence of the one or more historical events based on the one or more deviations.

2. The method of claim 1, wherein identifying the unique parameter comprises:
identifying one or more sets of parameters based on the historical data associated with the one or more historical events;
extracting relationship between the one or more sets of parameters; and
identifying a unique parameter among the one or more sets of parameter based on the relationship.

3. The method of claim 2, wherein the one or more sets of parameters may be functional properties associated with a mechanical or electrical system and environmental conditions surrounding the mechanical or electrical system.

4. The method of claim 1, wherein the event object comprises a model of a pattern pertaining to one or more events leading to the one or more historical events based on the unique parameter.

5. The method of claim 1, wherein the one or more deviations trigger one or more logical rules based on the event object.

6. The method of claim 1, wherein the determining one or more deviations comprises:
monitoring the event object based on real time data;
comparing the monitored event object to the one or more historical event; and
determining the one or more deviations of the event object based on the comparison.

7. A disaster management system to predict future occurrence of one or more historical events comprising:
a memory;
a processor coupled to the memory storing processor executable instructions which when executed by the processor causes the processor to perform operation comprising:
identifying a unique parameter based on historical data associated with the one or more historical events;
creating an event object based on the unique parameter;
determining one or more deviations of the event object from the one or more historical events; and
predicting future occurrence of the one or more historical events based on the one or more deviations.

8. The system of claim 7, wherein identifying the unique parameter comprises:
identifying one or more sets of parameters based on the historical data associated with the one or more historical events;
extracting relationship between the one or more sets of parameters;
identifying a unique parameter among the one or more sets of parameter based on the relationship.

9. The system of claim 8, wherein the one or more sets of parameters may be functional properties associated with a mechanical or electrical system and environmental conditions surrounding the mechanical or electrical system.

10. The system of claim 7, wherein the event object comprises a model of a pattern pertaining to one or more events leading to the one or more historical events based on the unique parameter.

11. The system of claim 7, wherein the one or more deviations trigger one or more logical rules based on the event object.

12. The method of claim 7, wherein the determining one or more deviations of the event object comprises:
monitoring the event object using real time data;
comparing the monitored event object to the one or more historical event; and
determining the one or more deviations of the event object based on the comparison.

13. A non-transitory computer readable medium including instructions stored thereon that when processed by at least one processor cause a lawful interception device to perform operations comprising:
identifying a unique parameter based on historical data associated with the one or more historical events;
creating an event object based on the unique parameter;
determining one or more deviations of the event object from the one or more historical events; and
predicting future occurrence of the one or more historical events based on the one or more deviations.

14. The medium as claimed in claim 13, wherein identifying the unique parameter comprises:
identifying one or more sets of parameters based on the historical data associated with the one or more historical events;
extracting relationship between the one or more sets of parameters;
identifying a unique parameter among the one or more sets of parameter based on the relationship.

15. The medium as claimed in claim 14, wherein the one or more sets of parameters may be functional properties associated with a mechanical or electrical system and environmental conditions surrounding the mechanical or electrical system.

16. The medium as claimed in claim 13, the event object comprises a model of a pattern pertaining to one or more events leading to the one or more historical events based on the unique parameter.

17. The medium as claimed in claim 15, wherein the one or more deviations trigger one or more logical rules based on the event object.

18. The method of claim 13, wherein the determining one or more deviations of the event object comprises:
monitoring the event object using real time data;
comparing the monitored event object to the one or more historical event; and
determining the one or more deviations of the event object based on the comparison.
